(19) United States
(12) Patent Application Publication
(10) Pub. No.: US 2011/0001355 A1
(43) Pub. Date: Jan. 6, 2011

(54) POWER SUBASSEMBLY FOR MICRO-HYBRID SYSTEM IN AN AUTOMOBILE

(76) Inventors: Roger Abadia, Neuilly Plaisance (FR); Michaël Chemin, Festigny (FR); Fabien Guerin, Chatillon (FR); Thierry Mandion, Champagne Sur Seine (FR); Patrick Rondier, Montmagny (FR); Cédric Leboeuf, Benfeld (FR)

Correspondence Address: BERENATO & WHITE, LLC, 6550 ROCK SPRING DRIVE, SUITE 240, BETHESDA, MD, 20817, US

(21) Appl. No.: 12/599,584

(22) PCT Filed: May 7, 2008
(86) PCT No.: PCT/FR08/50804

§ 371 Date: Sep. 22, 2010

(30) Foreign Application Priority Data
May 11, 2007 (FR) 0755002

(51) Int. Cl. H02J 1/00

(52) U.S. Cl. 307/10.1; 903/904

(57) ABSTRACT

The power sub-assembly (3) for a micro-hybrid system (1) in an automobile includes a AC-DC converter (8) with a transistor bridge (13), an energy storage device (10) and a power bus (9) including at least two substantially symmetrical and parallel conductors (22). The conductors (22) include respective substantially planar surfaces (23, 23′) facing each other. The power bus integrated in the power subassembly allows for a parasitic inductance that is by far lower than that of the standard cables in power subassemblies of the prior art, particularly in order to avoid overvoltage at the terminals of the transistors in the AC-DC converter.

The present invention is used in the automobile field. More particularly, it relates to a power subassembly for a micro-hybrid system in an automobile comprising an AC-DC converter with a transistor bridge, an energy storage device and a power bus.

For some years, the demand for “clean” vehicles has been increasing as a result of the requirements, on the one hand, to reduce fuel consumption and, on the other, to limit pollution.

Generally, hybrid systems and micro-hybrid systems are being developed for the purpose of meeting the aforementioned requirements.

Micro-hybrid systems with regenerative braking are known for example in which an alternator is used to draw mechanical torque, therefore producing vehicle braking. The alternator converts this drawn torque into an electric energy to charge an energy storage device in the form, for example, of a pack of ultracapacitors or of a battery. This regenerated energy is then returned to the various pieces of electric and electronic equipment that the automobile comprises. This energy can furthermore, in so-called “14+X” micro-hybrid systems with floating DC voltage, be used for starting the heat engine or for torque assistance for this heat engine.

However, the integration of this type of micro-hybrid system into the engine compartment of a modern automobile can cause problems. Indeed, a micro-hybrid system is made up of members which must be interconnected, wherein some of these members can be relatively bulky. Since the engine compartment of an automobile has a relatively limited space, automobile manufacturers find it increasingly difficult to integrate new systems therein. The result is a number of technical choices such as moving the energy storage device away from the other members of the micro-hybrid system, for example, by installing it in the boot. Thus, the connection cables, which form the power bus, can be long and introduce parasitic inductances likely to affect the micro-hybrid system when in a switched operation dynamic state.

The power bus, which is placed between the AC-DC converter of the micro-hybrid system and the energy storage device, causes a specific problem. Indeed, large pulse currents can be carried through this power bus between the AC-DC converter and the energy storage device. For example, large pulse currents occur during the starter mode operation of the electric rotating machine. The parasitic inductance of this power bus can, on the one hand, affect the energy efficiency at certain frequencies and, on the other, cause overvoltage due to resonance. Furthermore, the parasitic inductance can be detrimental to the electromagnetic compatibility.

Overvoltage due to resonance may lead to uncontrolled avalanche phenomena in MOSFET power transistors of the AC-DC converter, wherein these avalanche phenomena can affect the operation of these transistors, or damage them. The reliability of the micro-hybrid system can therefore be greatly reduced by these avalanche phenomena.

It is known, in the prior art, to use, as a power bus, a cable made up of two insulated and juxtaposed cylindrical conductors. This type of cable allows for a reduction in the parasitic inductance compared to other cabling solutions such as cabling using a single conductor forming a positive core, and requiring a return by the body of the automobile forming a negative core, this return acting as an earth. For example, for a cable length of 3 m, an inductance of approximately 3 μH is obtained.

The standard cable indicated above can be used in micro-hybrid systems for currents that can reach 600 A, particularly in the heat engine starting mode, as a result of the presence in the AC-DC converter of a capacitor of a few dozen μF, for example 60 μF, forming a passive filter limiting overvoltage.

For micro-hybrid systems with currents over 600 A, with this standard cable having a parasitic inductance of approximately 3 μH for a 3 m length, a capacitor of much greater capacity is required. For example, in a known micro-hybrid system, operating with currents of approximately 1100 A, a capacitor of approximately 2000 μF can be necessary at the AC-DC converter. Since this capacitor should preferably be integrated into the AC-DC converter, the result is an integration constraint that is difficult to meet due the bulkiness of the capacitor.

The subject matter of the invention is a power subassembly for a micro-hybrid system that does not have the disadvantages of the solutions of the prior art outlined above.

The power subassembly according to the invention comprises an AC-DC converter, an energy storage device and a power bus including at least two substantially symmetrical and parallel conductors.

According to the invention, the conductors comprise respective substantially planar surfaces facing each other.

The power bus integrated in the power subassembly of the invention allows for a parasitic inductance that is by far lower than that of the standard cables in power subassemblies of the prior art. Indeed, it is possible, for a 3 m length, to reduce the parasitic inductance to a value of between approximately 0.5 μH and approximately 2 μH.

The result is a reduction in design constraints particularly due to the fact that the capacitor at the terminals of the AC-DC converter can keep a low value.

Furthermore, this power bus allows a simple and favourable connection with good reliability.

According to the features of the invention:
The power bus comprises at least one flat conductor having a section of between approximately 10 mm² and approximately 60 mm². This feature of the invention allows the power subassembly to be standardised for a large number of micro-hybrid systems. Indeed, the variability of the section of at least one flat conductor allows an adjustment to the length of this conductor, which varies according to the location in the vehicle of the storage device, and an adjustment to the high currents carried by the power bus.
The power bus comprises at least one flat conductor having a rectangular section. This shape of at least one conductor, and more particularly of two flat conductors, allows the facing surfaces of these conductors to be maximised and therefore the value of the parasitic inductance of the conductors to be minimised.
The power bus comprises at least one conductor formed from a plurality of stacked metal sheets. This feature allows the handling of the conductor to be facilitated thanks to increased flexibility.
The power bus comprises at least one conductor formed from a metal braid. This feature allows, on the one hand, a low-cost braid to be used, and, on the other, the handling of the conductor to be facilitated thanks to increased flexibility.
The power bus comprises at least one conductor that is mainly made of copper, providing extremely good conductivity.
The power bus comprises at least one conductor that is mainly made of aluminium. The aluminium material allows the cost of the conductor to be reduced and also the weight thereof to be minimised.
The power bus comprises at least one conductor housed in a case.
The case is formed from an insulator placed between two conductors, and the insulator comprises a thickness of between approximately 0.1 mm and approximately 5 mm. Advantageously, this feature of the invention allows the inductance to be minimised while providing adequate insulation between two conductors.
The power bus comprises a connecting means, and this connecting means includes at least one lug formed at an end of a conductor by a machining method. This feature advantageously allows a saving to be made in terms of material and a contact resistance to be eliminated.
The connecting means comprises a lug made by boring or producing a hole in an end of a conductor.
The connecting means comprises a lug formed in the longitudinal axis of the respective conductor.
The connecting means comprises a lug formed by at least one bend of the end of a conductor.
The power bus comprises a connecting means, and the connecting means includes at least one lug assembled on an end of a conductor by crimping and/or welding.
The power subassembly includes a fixing member suitable for providing a mechanical and electrical joint between the connecting means and a complementary connecting means included in the energy storage device or in the AC-DC converter.
The power subassembly comprises at least one member forming a cap provided to protect a connecting means. The cap can advantageously hold the ends of the conductors forming the connecting means so as to make the power subassembly reliable. Furthermore, the cap allows the connecting means to be sealed.
The cap comprises a foolproof device which advantageously allows connection errors between the connecting means to be avoided and therefore the reliability of the power subassembly to be further increased.
The AC-DC converter is reversible.
The energy storage device comprises an ultracapacitor.

According to other aspects, the invention also relates to a micro-hybrid system comprising a power subassembly as described in brief above, and an automobile equipped with such a hybrid system.

Other features and advantages of the invention will emerge from the following detailed description with reference to the appended figures wherein:

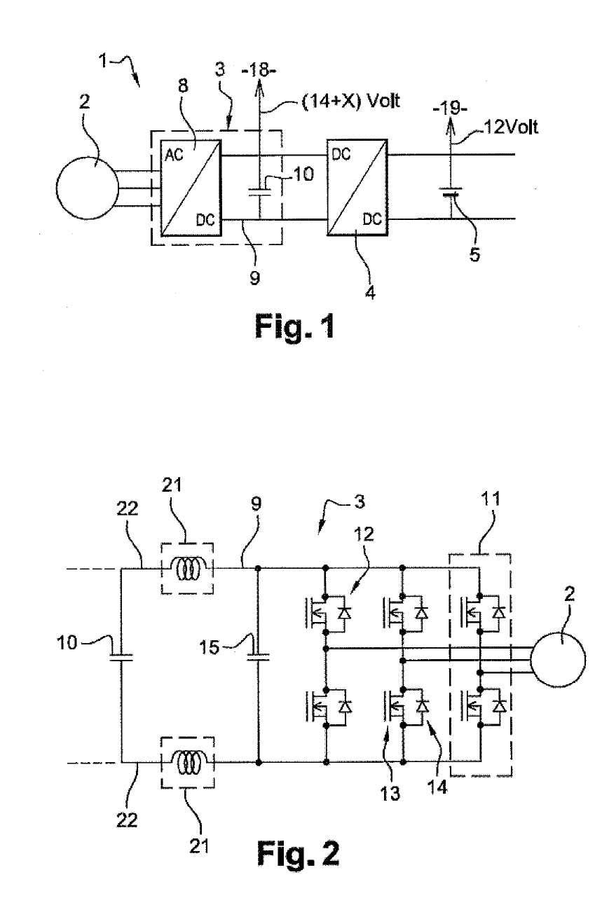

FIG. 1 is a simplified diagram of a micro-hybrid system including a power subassembly.

FIG. 2 is a detailed diagram of the power subassembly of FIG. 1.

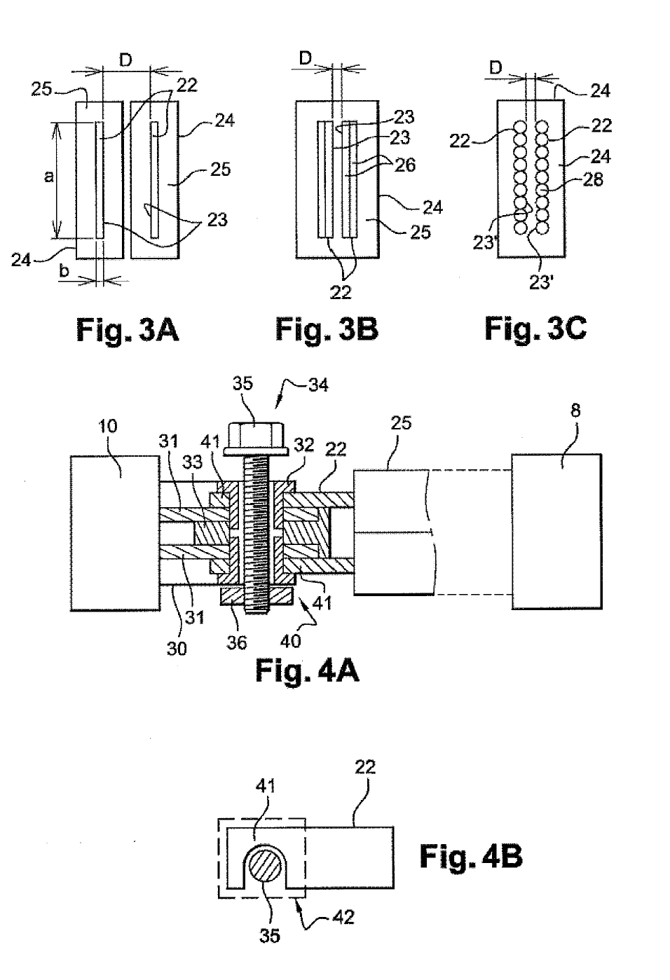

FIGS. 3A, 3B and 3C show three different embodiments respectively of a power bus included in a power subassembly according to the invention.

FIG. 4A is a detailed sectional view of a connecting means example located at ends of a power bus according to the invention.

FIG. 4B is a simplified sectional top view of the connecting means of FIG. 4A.

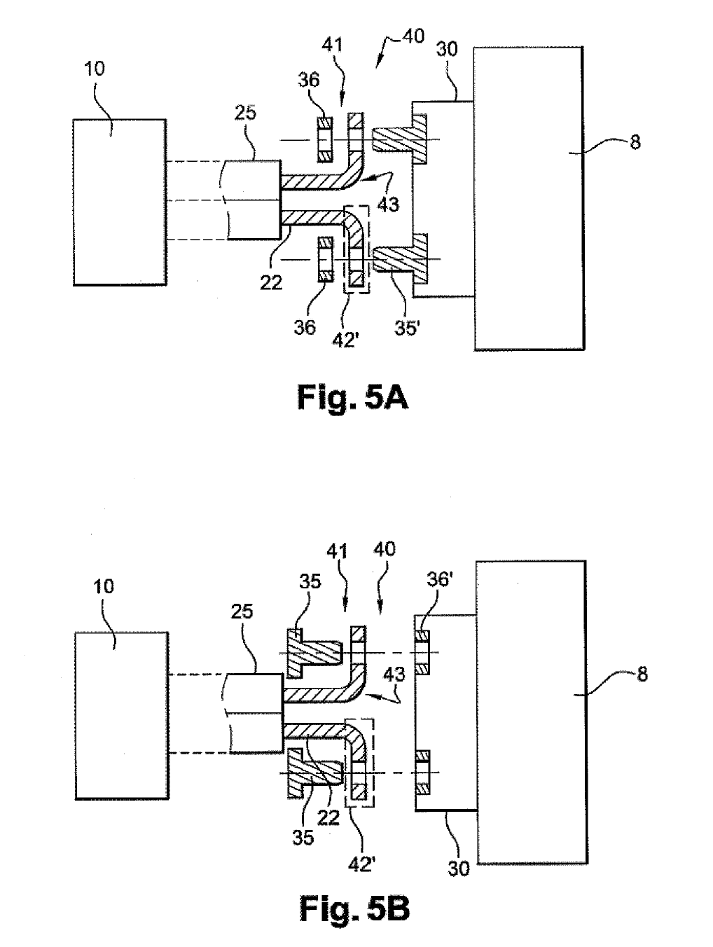

FIGS. 5A and 5B are sectional views of other connecting means examples located at ends of the power bus according to the invention.

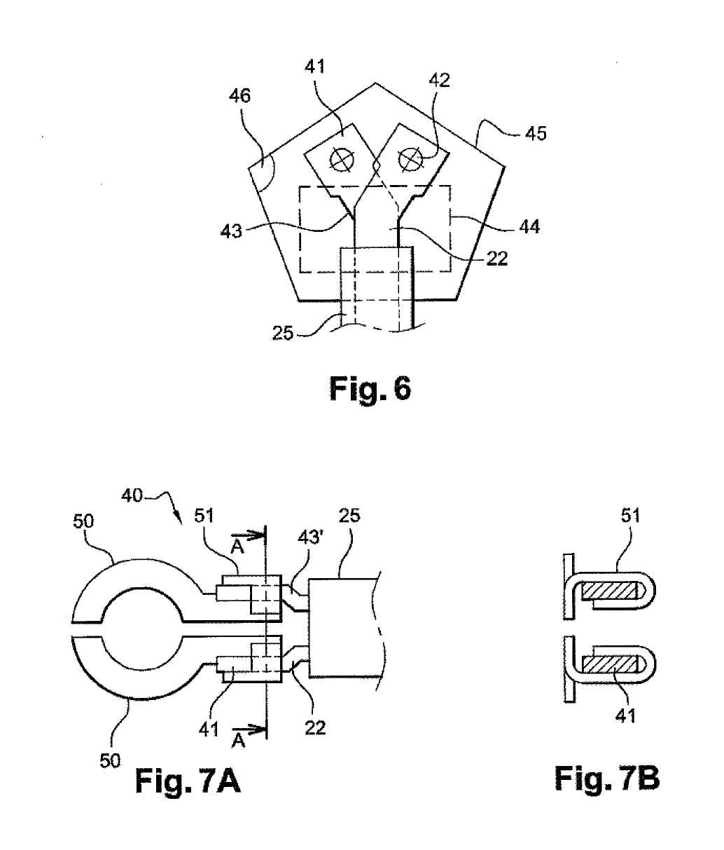

FIG. 6 is a sectional view of another connecting means example located at ends of the power bus according to the invention.

FIG. 7A is an elevation of another connecting means example located at ends of the power bus according to the invention.

FIG. 7B is a sectional view along an axis A, shown in FIG. 7A, of the connecting means of FIG. 7A.

FIG. 1 shows several modules of a starter-alternator micro-hybrid system 1 for an automobile. These modules include:
a reversible polyphase electrical rotating machine 2,
a power subassembly 3, connected to the machine 2, and including members 8, 9 and 10 described hereafter,
a DC-DC voltage converter 4, connected to the power subassembly 3, and
an energy storage device 5 connected to the DC-DC converter 4.

In this embodiment, the micro-hybrid system comprises an electrical rotating machine 2, of the starter-alternator type.

The power subassembly 3 includes:
a reversible AC-DC converter 8,
a power bus 9, and
an energy storage device 10, of the ultracapacitor type in this embodiment.

The AC-DC converter 8 particularly allows a DC voltage supplied by energy storage means of the vehicle to be converted into polyphase AC voltages used for driving the starter-alternator 2.

The power bus 9 allows energy to be transferred between the AC-DC converter 8 and the storage device 10.

The storage device 10 can include a plurality of ultracapacitors forming a pack and arranged in the form of cells in series.

The DC-DC voltage converter 4 allows bidirectional transfers of electric energy between the power subassembly 3 and the energy storage unit 5.

The energy storage unit 5 can include a conventional power supply battery, for example of the lead-acid battery type. The notion of a power supply battery 5 is understood in the present invention to cover any device forming a rechargeable electric energy reservoir, at the terminals of which a non-zero electric voltage is available, at least in a non-zero charge state of the device.

The energy storage unit 5 and the energy storage device 10, respectively the power supply battery 5 and the ultracapacitors 10, or pack of ultracapacitors, form the energy storage means. These storage means can particularly allow electric or electronic consumers of the vehicle to be fed. These consumers in an automobile are typically headlights, a radio, an air conditioning system, wipers, etc.

During starting of the heat engine, or during a heat engine torque assistance phase, if the energy storage means 5 and 10 are charged, and more particularly the pack of ultracapacitors 10, the starter-alternator 2 becomes available for an electric motor mode operation.

When the electric rotating machine 2 operates in electric motor mode, the AC-DC converter 8 operates such as to convert a DC voltage supplied by the energy storage means of the vehicle into polyphase AC voltages, more precisely three-phase voltages in the embodiment of FIG. 1. The polyphase AC voltages feed stator coils to cause the rotation of an output shaft (not shown) of the electric rotating machine 2. The end of this operation mode is decided by the micro-hybrid system 1 when the energy storage means 5 and 10 are empty or when the starting, or acceleration, stage is finished.

When the electric rotating machine 2 operates in alternator mode, more precisely, in not mal alternator mode or in regenerative braking alternator mode, the AC-DC converter 8 operates such as to convert polyphase voltages provided by the machine 2 into a DC voltage which is used to feed the electric distribution network of the vehicle and charge the energy storage means thereof.

In vehicles equipped with so-called “14+X” dual-voltage electric distribution networks, a floating high DC voltage network can be fed directly from the voltage present at the terminals of the pack of ultracapacitors 10. The energy provided to this 14+X network can then come from the pack of ultracapacitors 10, from the machine 2 operating as an alternator, through the AC-DC converter 8, or from the power supply battery 5 through the DC-DC converter 4 operating then as a voltage step-up.

As can been seen in FIG. 1, connections 18 and 19 of the micro-hybrid system are provided respectively for a 14+X network operating at a floating DC voltage and the 12 V network normally present in current automobiles.

The power subassembly 3 can be integrated in various places of the automobile, even at places other than under the vehicle bonnet. Therefore, the members 8, 9 and 10 of the power subassembly 3 can each be integrated at various places in an automobile. In one specific example, the AC-DC converter 8 is placed under the vehicle bonnet, the storage device 10 is placed in the vehicle boot, and therefore, the power bus 9 extends substantially over the entire length of the vehicle such as to connect both members 8 and 10.

FIG. 2 shows the power subassembly 3 according to the invention including the AC-DC converter 8 connected, on the one hand, to a starter-alternator 2, and on the other, to the pack of ultracapacitors 10.

The AC-DC converter 8 is a three-phase electric device allowing, particularly in the starter-alternator electric motor mode, a DC voltage to be converted into polyphase AC voltages. The AC-DC converter 8 comprises several bridge arms 11, of which there are three in this case, which is equal to the number of electric phases. Each bridge arm 11 comprises two electronically controlled switches 12, each formed from a power transistor 13 and from a freewheeling diode 14. The transistor 13 can, for example, be a MOSFET-type transistor. As is well known to a person skilled in the art, the MOSFET transistor 13 includes two operating states, namely a conducting state which permits a current to pass, and a blocked state which prevents a current from passing. Passing from one state to another occurs by switching. The transistor 13 has a third state called “passing into avalanche”. For example, this third state can occur when there is overvoltage at the terminals of a transistor 13 during switching from a conducting state to a blocked state. When the voltage at the terminals of the transistor 13 exceeds for example a value of 45 V, the avalanche phenomenon occurs, thus causing an extremely rapid increase in the temperature of the transistor. This temperature, called junction temperature of the transistor 13, can reach a value close to 200° C., which is much greater than the maximum junction temperature of 175° C. In this case, the transistor 13 becomes inoperative with respect to the switch function thereof and the operation of the bridge is disrupted or even stopped.

The AC-DC converter 8 also includes a member 15 for filtering the output voltage from the converter 8 so as to meet the requirements of electromagnetic compatibility. This filtering member comprises a capacitor 15 of low value, for example 60 μF, so as to form a passive filter.

The power bus 9 comprises at least two substantially symmetrical and parallel conductors 22, including a parasitic line inductance 21 which must be as reliable as possible so as to optimise the transfers of energy via the power bus 9.

When the starter-alternator 2 operates as an electric motor, for example to start the heat engine, the currents flowing through the power bus 9 and the AC-DC converter 8 are extremely high, and can reach 1100 A.

FIG. 3A shows a first embodiment of the power bus 9 including substantially symmetrical and parallel conductors 22, that are housed in a case 24 formed from an insulator 25. The conductors 22 comprise respective planar surfaces 23 facing each other.

The power bus 9 according to the invention guarantees the reliability of the micro-hybrid system 1. Indeed, the features of the conductors 22 according to the invention allow the inductance 21 to be limited in order to avoid overvoltage at the terminals of the transistors 13 in the AC-DC converter 8 and the resulting avalanche phenomena. A power bus 9 according to the invention allows an efficient energy transfer between the storage means 5 and 10 and the starter-alternator 2, in spite of a considerable length of the conductors 22 and of high values of currents.

As shown in FIG. 3A, both conductors 22 have a rectangular section. This rectangular section is defined by a thickness b and a width a. The conductors 22, called flat conductors, include an inductance 21 which is a function of the parameters a and b.

Therefore, to reduce the inductance 21 linked with a conductor 22, the width a should be increased and the thickness b reduced so as to have a surface 23 that is as large as possible, with a constant section. In accordance with specific embodiments of the invention, and according to the uses thereof, a flat conductor 22 comprises a rectangular section that varies between approximately 10 mm² and approximately 60 mm². This rectangular shape of the section of the conductors 22 allows the electromagnetic coupling to be improved and allows for an inductance value of between approximately 0.5 μH and approximately 2 μH.

FIG. 3B illustrates a second embodiment of the power bus 9 according to the invention, with flat conductors 22. In this embodiment, the flat conductors 22 comprise a plurality of stacked metal sheets 26. As shown in FIG. 3B, a flat conductor 22 is formed from two stacked metal sheets 26. This embodiment allows for the line inductance 21 to be decreased and the flexibility of the conductor 22 to be increased.

Furthermore, both flat conductors 22 of FIG. 3B are housed in the same case 24. This feature allows the thickness of the insulator 25 that forms the case 24 to be minimised so as to decrease a distance D between two flat conductors 22. The insulator is particularly placed between two conductors corresponding to positive and negative cores respectively so as to insulate them from each other. Minimising the distance D between two flat conductors 22 allows the line inductance 21 to be decreased even further. In accordance with specific embodiments of the invention, and according to the uses thereof, the thickness of the insulator can for example be between approximately 0.1 mm and approximately 5 mm. These uses allow the inductance value to be reduced further to a value of between approximately 0.5 μH and approximately 1.5 μH, and induce cutoff frequencies for the bandwidth that are equal to approximately 2 MHz and approximately 20 MHz.

FIG. 3C shows a third embodiment of the power bus 9. In this embodiment, the conductors 22 comprise metal braids formed from a plurality of wires with a small section 28. The metal braids include substantially planar surfaces 23′ having the same function as the planar surface 23 described above with reference to FIG. 3A. This embodiment has the advantage of using low-cost conductors.

Preferably, the flat conductors 22 of the power bus 9 will be produced from a material mainly comprising copper in order to profit from an extremely low resistivity.

However, the flat conductors 22 can also be produced from a material mainly comprising aluminium. Aluminium allows for a lower cost compared to copper, while retaining a low resistivity. Furthermore, aluminium has the advantage of being lighter in weight compared to copper.

FIGS. 4A and 4B illustrate an example of a connecting means 40 located at ends 41 of the conductors 22 of the power bus 9 according to the invention. The power bus 9 comprises the connecting means 40 including at least one lug 42 formed at the end 41 of a conductor 22. This lug 42 is obtained here by producing a hole in the end 41 of a conductor 22. In an alternative, the lug 42 can of course be obtained by another machining method known to a person skilled in the art, for example by boring. The lug 42 is formed, unbent, in the longitudinal axis of the end of the respective conductor 22. At one end of the power bus 9, the lugs 42 of the conductors 22 are arranged in parallel, i.e. facing each other.

It is noted that this embodiment of FIGS. 4A and 4B, with an obtained lug 42, advantageously allows a saving in terms of material and therefore a reduction in cost. Furthermore, the obtained lug 42 allows a contact resistance to be eliminated compared to an assembled lug.

In this example of the connecting means 40 illustrated in FIGS. 4A and 4B, the obtained lug 42 is fixed on a complementary connecting means 30, or terminal block, of the pack of ultracapacitors 10 as a result of the fixing member 34, which is formed here from a screw 35 and a nut 36. This fixing member 34 is inserted into the lugs 42. The fixing member 34 provides a mechanical and electrical joint between the connecting means 40 and the complementary connecting means 30.

The complementary connecting means 30 comprises two tracks 31 providing the mechanical and electrical connection of the conductors 22 to the pack of ultracapacitors 10, and an insulating member 33 inserted between the tracks 31 and providing an insulating function between these two tracks 31. The complementary connecting means 30 also includes insulating bushings 32, for example made of plastic. These insulating bushings 32 are arranged along the fixing member 34 in order to avoid a short circuit between the fixing member 34 and the ends 41 of the conductors 22.

To provide the connection between the complementary connecting means 30 and the conductors 22, the lugs 42 receive the tracks 31 and the insulator 33 of the terminal block 30 between the surfaces 23 of the ends 41 of the conductors 22. The insulating bushings 32 are then put in place and the screw 35 is inserted into a recess of the lug 42 (FIG. 4B), against the insulating bushings 32. The screw 35 passes through the connecting means 40 and the terminal block 30. The nut 36 is screwed onto the screw 35 in order to clamp the members 40 and 30.

Of course, other fixing members 34, other than the screw and the nut, can be adopted by a person skilled in the art according to the uses of the invention. For example, the fixing member 34 can comprise a screw or a pin.

The connection of an end of the power bus with the pack of ultracapacitors has been detailed above, with reference to FIGS. 4A and 4B. In this embodiment, a similar connection is provided between the other end of the power bus and the converter (AC-DC). However, in other embodiments of the invention, the connections at the ends of the power bus can be different and comprise for example a connection of the type described below, with reference to FIGS. 5A and 5B.

FIGS. 5A and 5B therefore illustrate other examples of the connecting means 40 located at ends 41 of the power bus 9 connected to the terminal block 30 of the AC-DC converter 8.

In these examples of the connecting means 40, the ends 41 of the flat conductors 22 are bent in opposite directions so as to form lugs 42′. In this embodiment, the ends 41 of the conductors 22 comprise substantially perpendicular bends 43. Of course, the bends 43 can be adapted and have shapes and sizes that are different to those in FIGS. 5A and 5B, particularly depending on the configuration of the terminal block 30. For example, the bends 43 can be formed with angles other than 90°.

In the example of FIG. 5A, the terminal block 30 incorporates a fixing screw 35′ for each lug 42′. The screws 35′ are secured to corresponding conductive metal tracks of the terminal block 30, for example by welding. Nuts 36 are also provided to fix, by clamping, the lugs 42′ on the screws 35′.

In the example of FIG. 5B, the terminal block 30 incorporates a nut 36 for each lug 42′. The nuts 36′ can be attached on conductive metal tracks of the terminal block 30 by welding, or the function thereof can be carried out by a threaded hole produced directly on these conductive metal tracks. Screws 35 are provided to fix, by clamping, the lugs 42′ on the screws 36′.

Therefore, as has just been described with reference to FIGS. 5A and 5B, the fixing member 34 can comprise at least one screw 35 and a nut 36 incorporated into the terminal block 30 of the AC-DC converter 8, in the embodiment of FIGS. 5A and 5B. More generally, the incorporation of the screw or the nut into the terminal block can be applied in the case of the connection of the power bus to the AC-DC converter or in that of the power bus to the pack of ultracapacitors.

The features, described above, of the embodiments of FIGS. 5A and 5B advantageously allow each of the obtained lugs 42′ to be clamped on the terminal block in a single operation and therefore the method of joining the members 30 and 40 to be simplified. These features also allow the installation of insulating bushings to be eliminated and the compactness of the power subassembly 3 to be improved.

With reference to FIGS. 7A and 7B, another example of a connecting means 40 comprising two attached lugs 50 is now briefly described.

As shown in FIGS. 7A and 7B, the connecting means 40 comprise two lugs 50 joined by crimping and welding on the ends 41 of the conductors 22. Of course, in other examples of a connecting means, the lugs can be joined by crimping or welding. The lugs 50 are thus “attached” on the ends 41 of the conductors 22. Each attached lug 50 includes a member 51 for holding the end 41 of a conductor 22. The end 41 is inserted into the holding member 51 before being crimped and welded with this member 51. The flat conductors 22 include bends 43′ giving them a shape adapted to the members 51 for holding the attached lugs.

The lugs 50 illustrated in FIG. 7A are suitable to be fixed to a terminal block (not shown) included in the AC-DC converter 8 or in the pack of ultracapacitors 10.

In accordance with the invention, a cap 45 can be provided to protect a connecting means 30 or 40. The cap 45 can allow, in some embodiments of the power subassembly according to the invention, the reliability thereof to be particularly improved, for example in terms of electrical protection, against short circuits, or in terms of protection against the environment.

As shown as an example in FIG. 6, the connecting means 40 can also comprise a member forming a cap 45 provided to protect a connecting means 30 or 40. The cap 45 can be made of plastic.

In an alternative, for example, when enhanced impermeability with respect to water or dust is required, the plastic cap 45 can comprise an overmould 44 of the flat conductors 22 with the material of the cap 45, as illustrated in FIG. 6.

Furthermore, the plastic cap 45 can include a foolproof device 46 so as to avoid errors with members 30 and 40.

Of course, the invention is not limited to the implementation examples which have just been described. It notably has particularly advantageous uses in combination with the so-called 14+X dual-voltage network system. Of course, the invention is also used in combination with a system including an electric rotating machine operating as an alternator, or an electric rotating machine operating as a starter-alternator.

1. A power subassembly for a micro-hybrid system in a vehicle comprising:
a reversible AC-DC converter (8) with a transistor bridge (13),
an energy storage device (10),
a power bus (9) including at least two substantially symmetrical and parallel conductors (22),
characterized in that said conductors (22) include respective substantially planar surfaces (23, 23′) facing each other.

2. A power subassembly according to claim 1, characterized in that the power bus (9) comprises at least one flat conductor (22) having a section of between approximately 10 mm² and approximately 60 mm².

3. A power subassembly according to claim 1, characterized in that the power bus (9) comprises at least one flat conductor (22) having a rectangular section.

4. A power subassembly according to claim 1, characterized in that the power bus (9) comprises at least one conductor (22) formed from a plurality of stacked metal sheets (26).

5. A power subassembly according to claim 1, characterized in that the power bus (9) comprises at least one conductor (22) formed from a metal braid.

6. A power subassembly according to claim 1, characterized in that the power bus (9) comprises at least one conductor (22) that is mainly made of copper.

7. A power subassembly according to claim 1, characterized in that the power bus (9) comprises at least one conductor (22) mainly made of aluminum.

8. A power subassembly according to claim 1, characterized in that the power bus (9) comprises at least one conductor (22) housed in a case (24).

9. A power subassembly according to claim 1, characterized in that the case (24) is formed from an insulator (25) placed between two conductors (22) and in that the insulator (25) comprises a thickness of between approximately 0.1 mm and approximately 5 mm.

10. A power subassembly according to claim 1, characterized in that the power bus (9) comprises a connecting means (40), said connecting means (40) including at least one lug (42, 42′) formed at an end (41) of a conductor (22) by a machining method.

11. A power subassembly according to claim 10, characterized in that the connecting means (40) comprises a lug (42, 42′) made by boring or producing a hole in an end (41) of a conductor (22).

12. A power subassembly according to claim 10, characterized in that the connecting means (40) comprises a lug (42, 42′) formed in the longitudinal axis of the respective conductor (22).

13. A power subassembly according to claim 10, characterized in that the connecting means (40) comprises a lug (42, 42′) formed by at least one bend (43) of the end (41) of the conductor (22).

14. A power subassembly according to claim 1, characterized in that the power bus (9) comprises a connecting means (40), said connecting means (40) including at least one lug (50) joined on an end (41) of a conductor (22) by crimping and/or welding.

15. A power subassembly according to claim 10, characterized in that it includes a fixing member (34) suitable for providing a mechanical and electrical joint between the connecting means (40) and a complementary connecting means (30) included in the energy storage device (10) or in the AC-DC converter (8).

16. A power subassembly according to claim 10, characterized in that it comprises a member forming at least one cap (45) provided to protect a said connecting means (40, 30).

17. A power subassembly according to claim 16, characterized in that the cap (45) comprises a foolproof device (46).

18. A power subassembly according to claim 1, characterized in that the energy storage device (10) comprises an ultracapacitor.

19. A micro hybrid system for a vehicle comprising a power subassembly (3) according to claim 1.

20. A vehicle comprising a micro-hybrid system (1) according to claim 19.
